(19) United States
(12) Patent Application Publication
(10) Pub. No.: US 2024/0161655 A1
(43) Pub. Date: May 16, 2024

(54) GEO-ANALYSIS MODELS COMPONENTIZED PRESENTER

(71) Applicant: Nanjing Normal University, Nanjing (CN)

(72) Inventors: Min CHEN, Nanjing (CN); Fengyuan ZHANG, Nanjing (CN); Teng ZHONG, Nanjing (CN); Songshan YUE, Nanjing (CN); Guonian LV, Nanjing (CN); Yongning WEN, Nanjing (CN)

(21) Appl. No.: 18/055,060

(22) Filed: Nov. 14, 2022

(51) Int. Cl. G09B 23/40

(52) U.S. Cl. CPC G09B 23/40

(57) ABSTRACT

The subject invention pertains to a geo-analysis model that can calculate geographical indicators in the real world based on specific calculation methods and computer programs. The operation of the geo-analysis model can help users understand the operational rules of the real world and predict the future, providing decision support for concerned members. A geo-analysis model componentized presenter enables the geo-analysis model to be presented in the form of assembled components, as well as abstract digital, theoretical, or academic constructs, or physical objects, to help users understand and use the model.

### BACKGROUND OF THE INVENTION

The geo-analysis model is a type of tool that can calculate various kinds of geographical indicators in the real world based on specific calculation methods and computer programs. The geographical data and indicators calculated by the geo-analysis model are often related to the real geographical world. In consequence, the operation of a geo-analysis model can help users understand the operation rules of the real world and predict future outcomes, which can provide decision support, communication efficiency, and other benefits.

### BRIEF SUMMARY OF THE INVENTION

Embodiments of the subject invention provide a geo-analysis model componentized presenter, which enables the geo-analysis model to be presented in the form of assembled components, as well as the abstract (e.g., digital, theoretical, or academic) geo-analysis model can be expressed by actual (e.g., physical) geographic model objects, to help users understand and use the model.

A geo-analysis model can contain a large number of abstract processes, which can be difficult to be expressed in real objects, so that users cannot understand the organization structure and application method of a geo-analysis model in a short time. The intuitive feeling of the geo-analysis model not only makes contribution for users to quickly understand the geo-analysis model, but also helps users make reasonable use of the geo-analysis model for carrying out geographical simulation, so that the corresponding geographical issues can be solved. Embodiments can help users to form a preliminary and intuitive understanding of the geo-analysis model through a physical expression of the geo-analysis model. By means of an intuitive understanding towards the geo-analysis model, users are able to better understand and use the geo-analysis model. Certain embodiments of the subject invention can be described as follows: Presentation of a geographic model can help describe the geo-analysis model based on the attributes, behaviors, running logic, and other aspects, and uses components with different shapes and colors to describe or represent the above-mentioned features of the geo-analysis model, and represents the larger scope of the geo-analysis model via a final assembly. Embodiments provide aid for users to understand the geo-analysis model intuitively, and expedite or enhance users' cognition, understanding and use of the geo-analysis model.

Embodiments provide a geo-analysis model componentized presenter to support the user's intuitive understanding, comprehension, and feeling of the geo-analysis model. Embodiments provide a geo-analysis model in the form of a computer program based on a series of spatial algorithms, which can be adopted to help calculate various indicators in the real world, so as to assist users in understanding various states of the real world. The geographical environment simulated by the geo-analysis model can be closely related to human life, including hydrology, atmosphere, soil, and other features that affect human beings in their environment. In addition, human activities are also constantly affecting the surrounding environment. As a consequence, the geo-analysis model can simulate and predict various geographical conditions, thus helping humans recognize the real world and promoting the harmonious development of the human-nature relationship. Therefore, the user's understanding of the geo-analysis model can be of vital importance. The characteristics of a geo-analysis model can be highly abstract, often to the extent that there can be difficulty in expressing its quantitative process and application scenarios with various entities. It may be hard for users to intuitively understand the geo-analysis model. Embodiments provide a geo-analysis model componentized presenter to help model users intuitively understand the various features of the geo-analysis model. Through a variety of materialized expressions, the use of components assembly of various elements, the establishment of a geographical model entity can therefore be intuitively comprehended. In the process of model assembling, by analyzing the geo-analysis model, multiple groups of relevant information concerned with the geo-analysis model can be acquired. By having various components with different meanings, including model name, running behavior, category, input and output, and other components, model assembling can be carried out to assemble the components of a geo-analysis model with an intuitive expression form, which allows different users to have fast access to understand the various individual attributes of the geo-analysis model, so that users can more quickly, more easily, and more fully understand the overall geo-analysis model.

Embodiments provide a geo-analysis model componentized presenter that features geographical modeling and lowers the threshold for users to understand the geo-analysis model through the expression of geographical model entities, so as to facilitate model users to quickly and intuitively understand the geo-analysis model. Embodiments of the subject invention can provide numerous advantages, including the following:

(1) The analysis and description of a geo-analysis model are often determined by its characteristics, so various conceptual processes of a geo-analysis model are generally included in the attribute characteristics. Under normal circumstances, such conceptual processes relate to the calculation process of some broad data, it can be therefore not easy to be naturally understood by users of a geo-analysis model (e.g., such as input and output data, algorithm process and other elements usually included in the algorithm.) Existing geo-analysis models are often described in either structured formats (e.g., JSON, XML, or other file specifications) or unstructured formats (e.g., papers, images, or vivid multimedia documents.) These two descriptions can be highly abstract, beneath which there can be still a process of information indexing and information accessing. Thus, embodiments of the subject invention can assist model users in naturally and quickly obtaining the vivid attribute information of the geo-analysis model through enhanced descriptions.

(2) In the way of display of traditional geo-analysis model information, of which display method can usually be through the classification display of its attributes, using tables, charts and other forms. Such displays can better represent various attributes of the geo-analysis model, while in essence, a large amount of information can be displayed in the form of text, such displays are often still lacking intuitive communication of the attributes. So, it's difficult for users to generate a vivid impression in the process of cognition, understanding and usage. Embodiments can make it easier for the model users to perceive visual context in the process of using the model.

Embodiments provide a componentized and assembled geo-analysis model presenter, which can express the attributes and features of the geo-analysis model by analyzing various elements of the model using different natural components such as colors and shapes, to help users quickly understand the relevant detailed information of the geo-analysis model, as well as understand the higher level concepts of the geo-analysis model.

### BRIEF DESCRIPTION OF THE DRAWINGS

FIG. 1 illustrates a high-level flow chart of the overall framework of a geo-analysis model componentized presentation process in accordance with an embodiment of the subject invention.

FIG. 2 illustrates a Geo-analysis Model Componentized Presenter (top side perspective view) in accordance with an embodiment of the subject invention.

FIG. 3 illustrates a Geo-analysis Model Componentized Presenter (bottom side perspective view) in accordance with an embodiment of the subject invention.

FIG. 4 illustrates a Geo-analysis Model Componentized Presenter (internal structure) in accordance with an embodiment of the subject invention.

FIG. 5 illustrates a Model system component in accordance with an embodiment of the subject invention.

FIG. 6 illustrates a Model subject in accordance with an embodiment of the subject invention.

FIG. 7 illustrates a series of Model input/output plug-ins in accordance with an embodiment of the subject invention.

FIG. 8 illustrates a Model running sub-components and process indicator sub-components in accordance with an embodiment of the subject invention.

FIG. 9 illustrates a soil and water assessment (SWAT) scale model in accordance with an embodiment of the subject invention. In this embodiment, the model represents a small watershed to river basin, used to simulate the quality and quantity of surface and ground water and predict the environmental impact of land use, land management practices, and climate change.

### DETAILED DISCLOSURE OF THE INVENTION

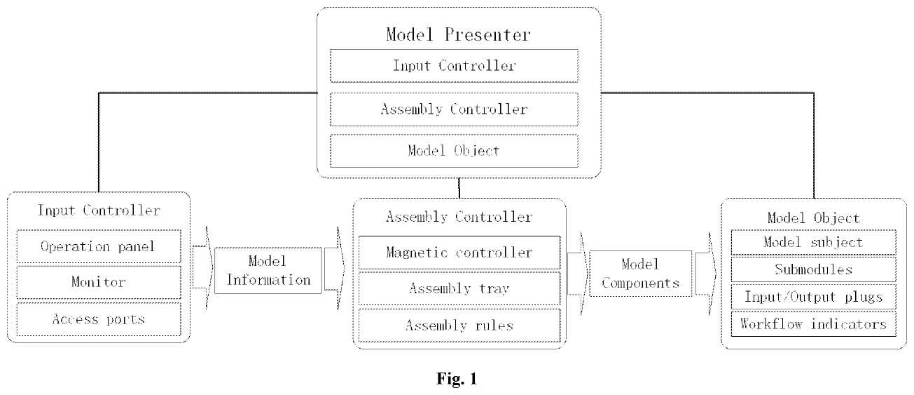

The overall framework of one embodiment of the subject invention is shown in FIG. 1. The attributes of a geo-analysis model are often highly conceptual and abstract, so the presenting process of a geo-analysis model can be divided into three processes: model parsing, model assembly, and presenting of the model object. Based on these three processes, embodiments of the subject invention can split into three main modules, which are the input controller, assembly controller and model object.

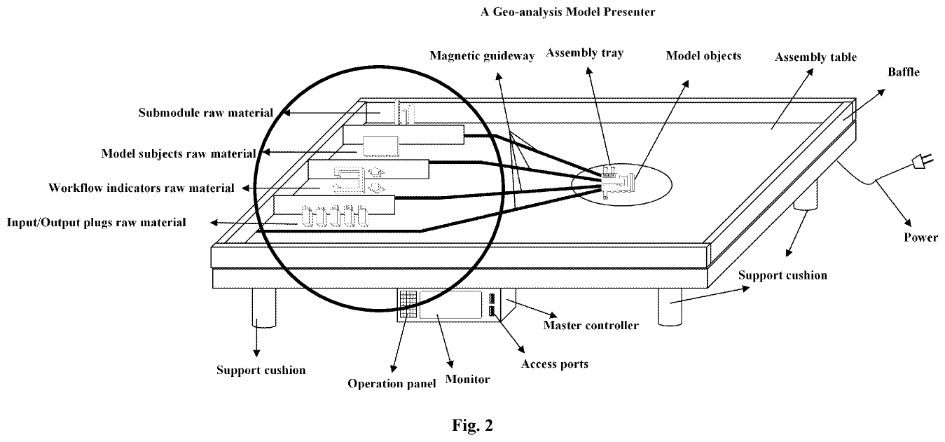

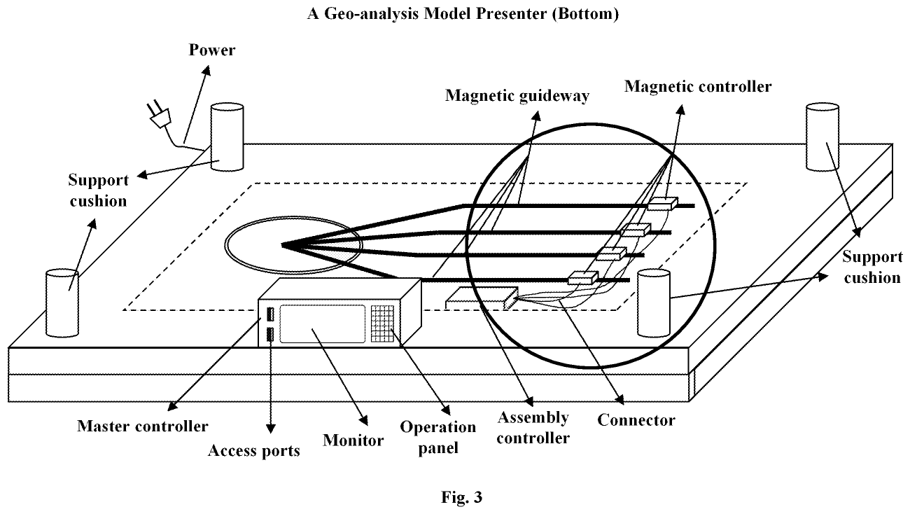

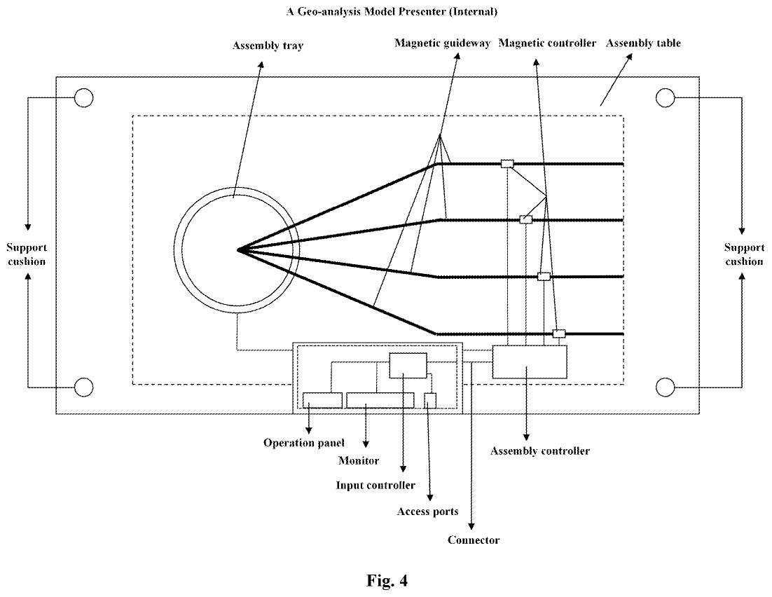

Embodiments can provide two parts involved in the geo-analysis model componentized presenter: 1) The geo-analysis model parsing and assembly device; 2) The object of the geo-analysis model. The appearance and overall structure of an exemplary and non-limiting embodiment of the geo-analysis model parsing and assembly device are shown in FIG. 2 and FIG. 3, of which the internal structure is shown in FIG. 4. The geo-analysis model parsing and assembly device can include the input controller and the assembly controller of the geo-analysis model. The input controller can be designed for model access and model information parsing, and the assembly controller can be designed for magnetic control, assembly tray, and assembly planning in the geo-analysis model assembly. The geo-analysis model objects include the model subject, submodules, input/output plug, and workflow indicator, which can be used for the final assembly and presentation of the geo-analysis model.

The user can import the relevant information about geo-analysis models into the geo-analysis model parsing and assembly device to produce an object of the geo-analysis model, which can contain the model subject, submodule, input/output plug, workflow indicator for the final assembly, and presenting of the geo-analysis model.

In certain embodiments, the geo-analysis model parsing and assembly device can provide two types of physical objects: 1) the Raw material of the model object; 2) the object of geo-analysis model.

In the raw material of model object, embodiments can provide: 1) subject information; 2) physical information; 3) resource connector. The subject information of raw material of the geo-analysis model can include name, interface number, and type (model subject, submodule, input/output plug, and workflow indicator.) The physical information of raw material of the geo-analysis model can include shape, color, weight, electromagnetic field, and additional sensors. Once a certain sub-component of the geo-analysis model is placed on the geo-analysis model parsing and assembly device, the physical qualities of the sub-component can be registered on the geographic model parsing and assembly device. A resource connector can be applied to represent the interaction between the imported geographic model information and raw materials of the geographic model. The interaction method can be provided through the additional sensor-derived qualities of raw materials of the geographic model.

The physical information of the geo-analysis model can be controlled by some or all of the physical information of the raw materials. The resource connector can contain the information related to the imported geo-analysis model information from some or all of the assembled raw materials.

A geographic model parsing and an assembly device provide two types of devices: 1) supporting device; 2) general controller.

The supporting device can provide a multiplicity of (e.g., four; alternatively 1, 2, 3, 5, 6, 7, 8, 9, or more than 9) raw material supplies, an assembly tray, a multiplicity of (e.g., four; alternatively 1, 2, 3, 5, 6, 7, 8, 9, or more than 9) magnetic guideways, a supporting table, and a multiplicity of (e.g., four; alternatively 1, 2, 3, 5, 6, 7, 8, 9, or more than 9) boundary baffles. In certain embodiments, four (alternatively 1, 2, 3, 5, 6, 7, 8, 9, or more than 9) raw material supplies can be provided, including a submodule raw material supply, a model subject raw material supply, a workflow indicator sub-module raw material supply, and an input/output plug raw material supply. These raw material supplies can store relevant raw materials required by the geo-analysis model. An assembly tray can be provided to route, position, or place specified raw material supplies or physical components of geographical models to represent the combination of a specified geo-analysis model, subsystem, or component of a geo-analysis model. In certain embodiments, four (alternatively 1, 2, 3, 5, 6, 7, 8, 9, or more than 9) magnetic guideways are configured to move specified raw materials required by the geographical model to the assembly tray by magnetic force. The Supporting table can include four (alternatively 1, 2, 3, 5, 6, 7, 8, 9, or more than 9) raw material supplies, an assembly tray and four magnetic guideways. Four (alternatively 1, 2, 3, 5, 6, 7, 8, 9, or more than 9) boundary detectors sense if one or more physical objects gathered on the table extend beyond the boundary of the table.

In certain embodiments, the general controller can provide: a power cord, a switch control, a master control, a monitor, an operation panel, and two access ports. The power cord can provide power for the geo-analysis model parsing and assembly device. The switch panel can connect or disconnect the power cord of the geo-analysis model parsing and assembly device. The monitor can show selected information of the imported geo-analysis model on display. The operation panel can be configured and adapted to allow the user to select and import model information. The access ports can be configured and adapted for model access operations including importation of the geo-analysis model into the geographic model (e.g., via the geographic model parsing and assembly device). The input general control module of the geo-analysis model can provide 1) model information render, which can be used to parse and deconstruct the imported geo-analysis model, remove the conceptual characteristics of the geo-analysis model, and define final shape of the system of the geographic model; 2) connectors, which can be used for the message communication between the geographic model input general control module and the assembly general control module. The model information can be registered from the input control module to the assembly control by the connector. The assembly controller can provide: 1) model parsing interface, which can be used for parsing model information of geo-analysis models after importing. At the same time, the relevant raw materials can be indexed according to the imported information. 2) The operation controller can be used for the raw material assembly for geo-analysis. The raw materials can include model subject, submodule, input/output plug, and workflow indicator sub-components. 3) Assembly tray connector can be used for the message communication between the assembly control module and the assembly tray. The assembly tray uses the model object as the foundation, then with the help of the information registered by operation control, assembles components of the model object by magnetic control.

The geo-analysis componentized description method in embodiments of the subject invention can be configured to express different abstract geo-analysis models by different components. The characteristics (such as colors, shapes, and other visible, tactile, or auditory parameters) of a model component can express the abstract attributes of geo-analysis models, and give an intuitive expression of geo-analysis models. So, the input control module and assembly module play very important roles in the process of parsing and assembling the geo-analysis model. The input control module can include: 1) model parsing rule library; 2) description field library. The assembly general control module can include: 1) the model raw material library; 2) the mapping rules library; 3) the assembly rules library.

In the input control module, the model parsing rule library can be configured to implement the model assembly by the rules in the library. The rules in the library can map the abstract attributes in heterogeneous geo-analysis models to the corresponding components. In the process of parsing the geographical model, due to the heterogeneity of geo-analysis models, for example, different geo-analysis models have different forms of input and output, so the attributes of geo-analysis models in the conceptual properties can have a wide variety of characteristics. The mapping rules for these characteristics can also be different. Therefore, the mapping rule library can be designed to store mapping rules between attributes of geo-analysis models and characteristics of model subjects. After model importing, embodiments of the subject invention can parse the information about the geo-analysis models, and the rules stored in this library can be the references for model assembly by model information.

In certain embodiments of the process of geo-analysis model information parsing, it can be necessary to specify relevant fields in the parsed geo-analysis models, so as to regulate the results of the parsed geo-analysis models. The description field library in certain embodiments of the subject invention can contain certain fields that need to be described for the geo-analysis model, including the model name, model category, input number, output number, running and, type, and other information. In certain embodiments some or all the information in the library corresponds to the drawn rules of the geo-analysis models. For example, there can be corresponding systematic rules for the description of the model category, including the study of the mixed model, the atmospheric model, and so on.

Embodiments of the model raw materials library can provide raw materials of the model subject, including model objects, submodules, input/output plug, and workflow indicators that can be joined with each other. Through the combination and series of these raw materials, a geo-analysis model system can be formed to directly express the characteristic information of the geo-analysis models. Meanwhile, a model object can be joined and connected in series with one or more submodules, input/output plugs, and workflow indicator sub-modules.

Embodiments of the mapping rules library can provide a series of mapping rules between raw materials and model components. By the mapping rules, a geo-analysis model can be drawn to the model storehouse, to map the required model objects, submodules, input/output plugs, and workflow indicators. On the table of geo-analysis model analysis and assembly, a certain quality of a geo-analysis model can correspond to raw material in the model storehouse, to be joined.

The assembly rules library contains a series of assembly rules with a mixed calling interface. The raw materials of the geo-analysis model can be spliced according to certain rules by assembly rules. In addition, the input/output (e.g., saw tooth) of the model object can be joined with an input/output plug. A model object raw material can join to one or more input/output plugs, submodules, and workflow indicator sub-modules on the model object.

The subject of the geo-analysis model can include the model object, submodules, input/output plugs, workflow indicators, and other devices that can be used for the final assembly and presentation of the geo-analysis model (in some embodiments, analogs to the raw materials of the geo-analysis model), including: 1) object information; 2) physical information; 3) resource connectors.

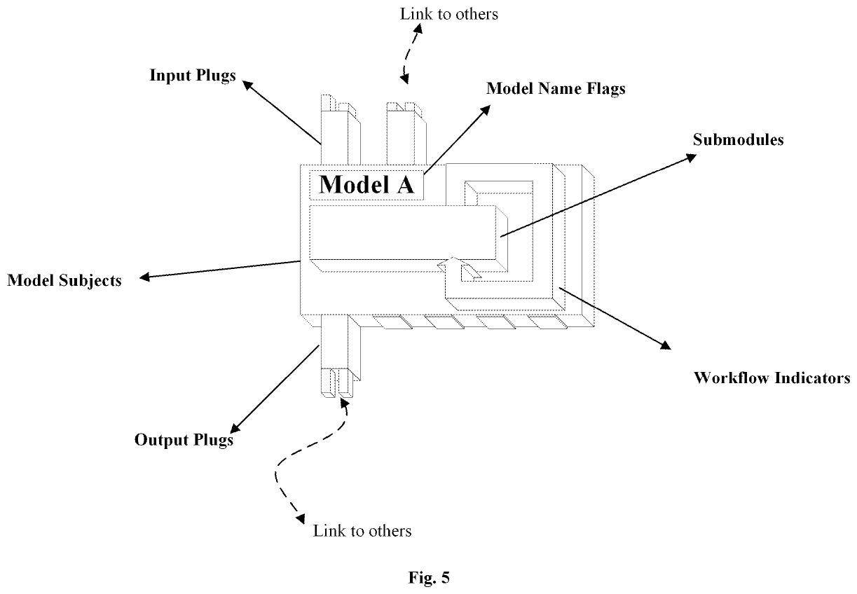

As shown in FIG. 5, the object information of the representation system can provide the object information of the raw materials of some or all of the gathered geo-analysis models.

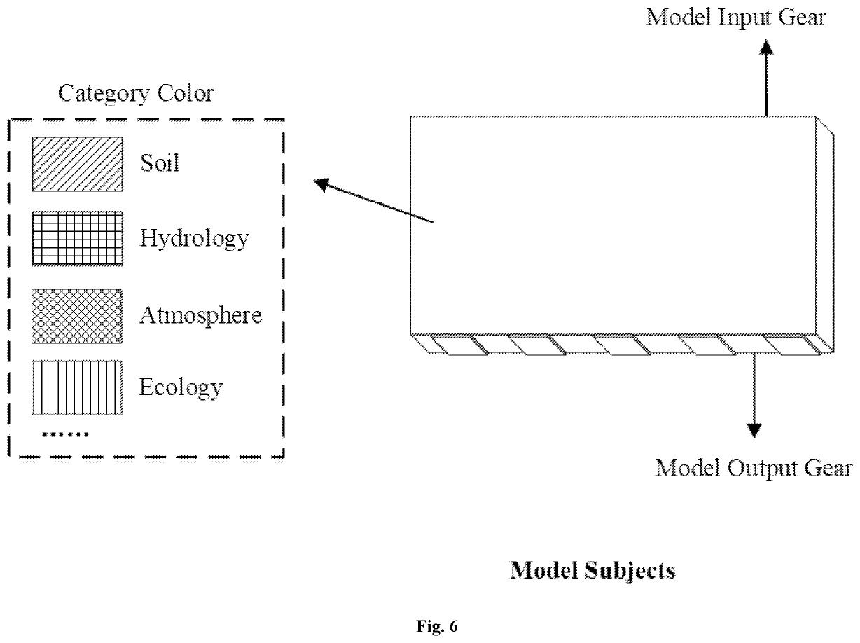

In the description of the geo-analysis model, there can be many parts used for the description of the geographic model, including the model object, input/output plug, submodule, and workflow indicator. As shown in FIG. 6, the model appearance can be adopted to represent the basic properties of the model, including for example, the model nameplate to represent the name and the object and color to represent the model category. Different colors can represent different types of geographical models, for example, in certain embodiments the blue represents the climatic model, the yellow represents the soil model, the gray represents atmospheric model, and the green represents the ecological model. In certain embodiments, models can provide a smooth surface with magnetism in front of the model body, which can be used to attract or attach relevant sub-components of the geographic model, and nameplates can be fabricated (e.g., engraved by laser) to represent the name of the geographic model. The upper and lower parts of the model body are provided with multiple teeth that can be implanted with input/output plug-ins, in which the top represents the input data and the bottom represents the output data. The number of implanted input/output plug-ins can indicate the number of input/output connections of the model. For example, when a model inputs two pieces of data and outputs one piece of data, it should have two data plug-ins above it and one data plug-in below it.

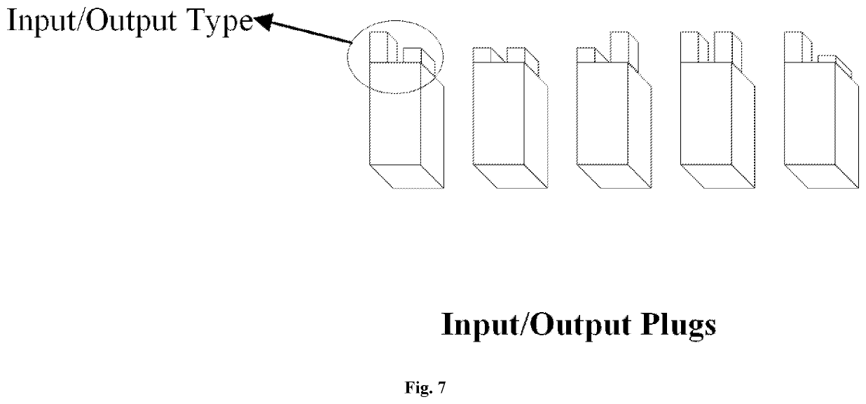

As shown in FIG. 7, in certain embodiments the input/output plug of the geo-analysis model can represent the number of model inputs/outputs, while the top of the data plug-in can have different shapes that can be adapted to represent different data types. When there are multiple model subjects, such shapes can be used to decide whether there is any link between two geo-analysis models. For example, when the input of one model and the output of the other model have the same data type, the geo-analysis model can immediately represent the corresponding connection relationship, so as to help users get link integration information between the models.

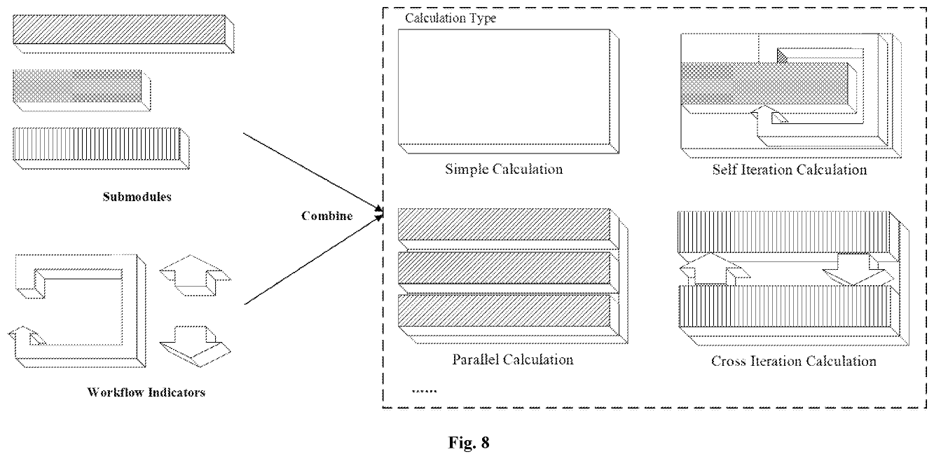

The submodule and workflow indicator of the geo-analysis model sub-component can be used together to represent the run logic of the geo-analysis model. As shown in FIG. 8, in certain embodiments the submodule represents the running sub-module within the geo-analysis model and also has the same color as the model object. The workflow indicator represents the running process of the geographic model, including for example, the self-succession module and mutual succession module. The combination of the two components can represent different run logic of geo-analysis models on the model object, such as simple calculation, self-constant calculation, parallel calculation, cross-constant calculation, and other run logic or calculation types.

Embodiments provide a novel set of products for the description of a geo-analysis model: through the presenter provided, the geo-analysis model can be more easily and efficiently analyzed and deconstructed, and the attributes and features of the geo-analysis model can be extracted. The relevant parts of the geo-analysis model can be assembled through the established design rules, to express the geographical model in a physical object. In certain embodiments, an assembled physical object representation of the geo-analysis model includes, comprises, consists of, or consists essentially of materials (e.g., submodule raw material, model subjects raw material, workflow indicators raw material, and/or input/outut plugs raw material) delivered (e.g., via a magnetic guideway, manual delivery, or other transport means) to an assembly tray and assembled (e.g., according to a set of assembly rules) to provide one or more model objects that make up a model in the model presenter. One or more input plugs of a first model object can connect to one or more output plugs of a second model object to link the first model object to the second model object. Through the direct visual sense of the model objects and/or the relationships between model objects, users can quickly understand the relevant information of the geo-analysis model to understand its conceptual aspect characteristics.

The overall framework of an embodiment of the subject invention is shown in FIG. 1. The attributes and features of a geo-analysis model are highly conceptual and abstract, so the presenting process of a geo-analysis model can be divided into three processes: model inspecting, model assembly, and model object presenting. Based on these three processes, embodiments can provide three main modules: the input control module, the assembly control module, and the model object.

Embodiments can provide two types of objects involved in the geo-analysis model componentized presenter: 1) a model parsing and assembling device; 2) a representative object of the geo-analysis model. In certain embodiments the geographical model parse and assembly device can include the general control module of geographical model input and the general control module of geographical model assembly, which in the geographical model import are respectively responsible for model access, model information analysis, operation control, magnetic control in geographical model assembly, model assembly tray control, and assembly coordination. The geo-analysis model description system can include the model body, operation sub-components, input/output plug-ins, process indication sub-components and other devices, which are applied for the final assembly and presentation of the geo-analysis model.

In the description of the geo-analysis model, the geo-analysis model can include the name, type, input and output, operation logic, and other information. In certain embodiments, after users import the geo-analysis models into the device, the input general control module in the device will automatically analyze the relevant attributes of the geo-analysis model, extract the relevant information, and preset the final shape of the entity of the geo-analysis model. Then, the input general control module can send the preset geo-analysis model entity to the assembly control module. The assembly control module analyzes the relevant raw materials required by the geo-analysis model and controls the magnetic drivers in the device to move the relevant raw materials required by the geo-analysis model to the model assembly tray by magnetic force. These materials can contain the model ontology, operational sub-components, input/output plug-ins, and process indicator sub-components in the entity components of the geo-analysis model. Afterward, the assembly tray applies the model subject as the foundation, and assembles other components into the model subject with its own rotation and magnetic control. The model subject can be a cuboid with a variety of colors that can be assembled in multiple (e.g., three) parts, including the front part, the upper part, and the lower part of the model subject. The front of model subject can be used to assemble the running sub-components and the process indicator sub-components, representing the running logic of the geo-analysis model. The input and output of the geo-analysis model are respectively represented for the upper part and lower part of the model subject, which are adopted to assemble the geo-analysis model referring to the number of input/output and the type of output/output.

In certain embodiments the user can indicate the model types through the model subject color, mark the model names through the brand logo on the model subject, express running logic through the running sub-components and process indicator sub-components, signify the numbers of model input/output through the number of plug-in input/output, and perform data types of the input/output through different tooth of output/output plug-ins. As a result, users are able to intuitively understand the name, type, running logic, input/output and other information of the geo-analysis model through the text, color, shape, plug-in, and the number of teeth on the plug-in. Additionally, when multiple models are generated, users may judge if the two geo-analysis models can be connected and integrated through input and output based on the different tooth shapes in the model subjects.

Based on the description method of the componentized geo-analysis model, the traditional description can be merely restricted to the structural or nonstructural category level. Embodiments of the subject invention can use the color, shape, and other characteristics of the physical object to directly express the qualitative information of the geo-analysis models.

In certain embodiments of the description method of the geo-analysis model, the expression of the traditional geo-analysis model still remains in the form of text expression. The text expression can be limited in its ability to show the qualitative information of the geo-analysis model, which has delayed the user's image of the geo-analysis model and has brought obstacles to the user in the understanding process of the geo-analysis model quality, behavior, logic and other information. On the foundation of the construction of the physical object of the geo-analysis model, embodiments can provide a physical system of the model component through the color, shape, symbol, and other characteristics of the physical object to express model attributes, interaction, logic, and other conceptual information, so as to help the user understand the geo-analysis model.

Based on the model parsing module in certain embodiments, various qualitative information of the geo-analysis model can be explored, aiming at the geo-analysis model of separation and difficulty in expression. Embodiments can advantageously break through the built-in impression of the geo-analysis models of separation by constructing presentation rules of different real objects, and the geo-analysis models will be expressed through specific methods. Such expression in the invention can facilitate the users' understanding, as well as help model users to achieve perception and use of geo-analysis models.

Embodiments of the subject invention can uniquely describe the quality of the geographic model; also, the shapes, colors, and characters in the assembled components can each express certain parts of the information related to the geographic model; furthermore, there are different assembly rules for the quality information of different models. However, the assembled components in related art systems often have no special meaning. Users can assemble themselves according to their needs and imaginations, and there are no strict assembly rules.

Related art systems and methods are often presented in terms of assembly, such as those for associated mounting assembly (e.g., Pan et al., U.S. Pat. No. 9,781,313). Related art methods and systems focus on the assembly of components, having certain assembly rules, and are used for the assembly of general components. Embodiments of the subject invention provide the expression of assembly results. Related art assembly methods placed in professional fields can include a modular geo-steering tool assembly, or standard timepiece movement with functional modules (Bittar et al., U.S. Pat. No. 8,222,902; Peters et al., U.S. Pat. No. 10,241,472). Embodiments of the subject invention can address different professional needs. The related art systems and methods are configured to serve the engineering field and the civil field, while the embodiments provide for the flexible expression of the geo-analysis model in the field of geographical research. In the engineering and civil field, this research can give a brief expression of the geo-analysis models that can be used in education. In the field of geographical research, this patent can help researchers recognize different geo-analysis models with detailed information, including running logic and input/output count, which can be used in model integration.

### MATERIALS AND METHODS

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting.

### Example 1—a Demonstration of Geo-Analysis Model Componentized Presenter: Soil and Water Assessment (SWAT) Model

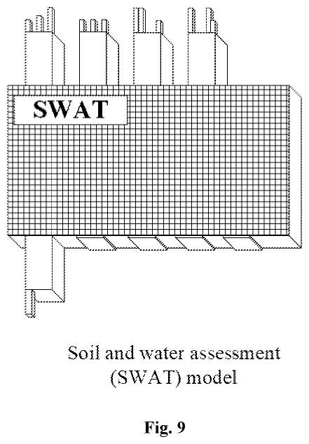

As shown in FIG. 9, this is a demonstration of the geo-analysis model presentation according to an embodiment of the subject invention. The provided soil and water assessment (SWAT) model is a small watershed-to-river-basin scale model used to simulate the quality and quantity of surface and ground water and predict the environmental impact of land use, land management practices, and climate change. The model has four kinds of input data: digital elevation model (DEM) data, soil type data, land use data, and meteorological data, and one output data: runoff data. So, in FIG. 9, the model has four input plugs and one output plug to express the corresponding input/output. The model flag shows the model's name: SWAT. The submodule in the model subject shows that the model running logic is simple calculation. The color of the subject shows the model belongs to the hydrologic domain.

Following are specific exemplary embodiments that illustrate structures and procedures for practicing the invention. These exemplary embodiments should not be construed as limiting.

Embodiment 1. A geo-analysis model componentized presenter for creating an improved representation of a geo-analysis model for a user, the presenter is comprising a geo-analysis model parsing and assembly device and an assembled physical object representation of the geo-analysis model.

Embodiment 2. The geo-analysis model componentized presenter of Embodiment 1, wherein the geo-analysis model parsing and assembly device comprises a supporting device and a general controller.

Embodiment 3. The geo-analysis model componentized presenter of Embodiment 2, wherein the supporting device comprises a multiplicity of raw material supplies, an assembly tray, a multiplicity of guideways, and a supporting table.

Embodiment 4. The geo-analysis model componentized presenter of Embodiment 3, wherein the multiplicity of raw material supplies comprises a submodule raw material supply, a model subject raw material supply, a workflow indicator sub-module raw material supply, and an input/output plug raw material supply.

Embodiment 5. The geo-analysis model componentized presenter of Embodiment 3, wherein the assembly tray is configured and adapted to route, position, or place specified raw material supplies or physical components of geographical models to represent the combination of a specified geo-analysis model, geo-analysis model subsystem, or component of a geo-analysis model.

Embodiment 6. The geo-analysis model componentized presenter of Embodiment 3, wherein the multiplicity of guideways are configured and adapted to move specified raw materials required by the geographical model to or from the assembly tray.

Embodiment 7. The geo-analysis model componentized presenter of Embodiment 6, wherein the multiplicity of guideways comprise magnetic guideways configured to move specified raw materials required by the geographical model to the assembly tray by magnetic force.

Embodiment 8. The geo-analysis model componentized presenter of Embodiment 3, wherein the supporting table comprises a multiplicity of table boundaries, and a multiplicity of boundary baffles, each boundary baffle, respectively, located at or near a respective table boundary.

Embodiment 9. The geo-analysis model componentized presenter of Embodiment 3, wherein the supporting table comprises a boundary detector configured and adapted to sense when one or more physical objects on the table extends in whole or in part beyond a respective table boundary.

Embodiment 10. The geo-analysis model componentized presenter of Embodiment 2, wherein the general controller comprises a power cord, a network interface, a switch panel, an operation display, an operation panel, and a model access module.

Embodiment 11. The geo-analysis model componentized presenter of Embodiment 10, wherein the power cord is configured and adapted to provide power for the geo-analysis model parsing and assembly device.

Embodiment 12. The geo-analysis model componentized presenter of Embodiment 10, wherein the network interface is configured and adapted to provide network connection for the entire geo-analysis model parsing and assembly device.

Embodiment 13. The geo-analysis model componentized presenter of Embodiment 11, wherein the switch panel is configured and adapted to connect or disconnect the power cord.

Embodiment 14. The geo-analysis model componentized presenter of Embodiment 10, wherein the operation display is configured and adapted to show selected information of the imported geo-analysis model on display.

Embodiment 15. The geo-analysis model componentized presenter of Embodiment 10, wherein the operation panel is configured and adapted to allow the user to select and import model information.

Embodiment 16. The geo-analysis model componentized presenter of Embodiment 2, wherein the model access module is configured and adapted to import the geo-analysis model into a geographic model format.

Embodiment 17. A geo-analysis model componentized presentation process for delivering improved representation of a geo-analysis model to a user via a model object, the process comprising:
activating an input control module to input model information;
activating an assembly control module to assemble a model object from model components, based on the model information; and
presenting the model object to the user.

Embodiment 18. The process of Embodiment 17, wherein:
the input control module comprises:
   an input operation;
   a model access operation, and
   a model parser operation; and
the assembly control module comprises:
   an assembly rules library,
   an assembly controller, and
   a relative motion controller.

Embodiment 19. The process of Embodiment 18, wherein:
the input operation comprises reading a data element in a geo-analysis model format;
the model access operation comprises converting the data element from the geo-analysis model format to a geographic model format;
the model parser operation comprises removing one or more conceptual characteristics of the geo-analysis model, and defining a final shape of a geographic model;
the assembly rules library comprises a series of assembly rules with a mixed calling interface;
the assembly controller is an assembly tray controller configured and adapted to route, position, or place specified raw material supplies or physical components of geographical models;
the relative motion controller is a magnetic motion controller; and
the model object comprises:
   at least one model subject,
   a multiplicity of model-submodules,
   a multiplicity of input/output plugs, and
   a multiplicity of workflow indicators.

Embodiment 20. A geo-analysis model componentized presenter for creating an improved representation of a geo-analysis model for a user, the presenter comprising a geo-analysis model parsing and assembly device and an assembled physical object representation of the geo-analysis model;
wherein the geo-analysis model parsing and assembly device comprises a supporting device and a general controller;
wherein the supporting device comprises a multiplicity of raw material supplies, an assembly tray, a multiplicity of guideways, and a supporting table;
herein the multiplicity of raw material supplies comprises a submodule raw material supply, a model subject raw material supply, a workflow indicator sub-module raw material supply, and an input/output plug raw material supply;
wherein the assembly tray is configured and adapted to route, position, or place specified raw material supplies or physical components of geographical models to represent the combination of a specified geo-analysis model, geo-analysis model subsystem, or component of a geo-analysis model;
wherein the multiplicity of guideways are configured and adapted to move specified raw materials required by the geographical model to or from the assembly tray;
wherein the multiplicity of guideways comprise magnetic guideways configured to move specified raw materials required by the geographical model to the assembly tray by magnetic force;
wherein the supporting table comprises a multiplicity of table boundaries, and a multiplicity of boundary baffles, each boundary baffle, respectively, located at or near a respective table boundary;
wherein the supporting table comprises a boundary detector configured and adapted to sense when one or more physical objects on the table extend in whole or in part beyond a respective table boundary;
wherein the general controller comprises a power cord, a network interface, a switch panel, an operation display, an operation panel, and a model access module;
wherein the power cord is configured and adapted to provide power for the geo-analysis model parsing and assembly device;
wherein the network interface is configured and adapted to provide a network connection for the entire geo-analysis model parsing and assembly device;
wherein the switch panel is configured and adapted to connect or disconnect the power cord;
wherein the operation display is configured and adapted to show selected information of the imported geo-analysis model on display;
wherein the operation panel is configured and adapted to allow the user to select and import model information;
wherein the model access module is configured and adapted to import the geo-analysis model into a geographic model format.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A geo-analysis model componentized presenter for creating an improved representation of a geo-analysis model for a user, the presenter comprising a geo-analysis model parsing and assembly device, and an assembled physical object representation of the geo-analysis model.

2. The geo-analysis model componentized presenter of claim 1, wherein the geo-analysis model parsing and assembly device comprises a supporting device and a general controller.

3. The geo-analysis model componentized presenter of claim 2, wherein the supporting device comprises a multiplicity of raw material supplies, an assembly tray, a multiplicity of guideways, and a supporting table.

4. The geo-analysis model componentized presenter of claim 3, wherein the multiplicity of raw material supplies comprises a submodule raw material supply, a model subject raw material supply, a workflow indicator sub-module raw material supply, and an input/output plug raw material supply.

5. The geo-analysis model componentized presenter of claim 3, wherein the assembly tray is configured and adapted to route, position, or place specified raw material supplies or physical components of geographical models to represent the combination of a specified geo-analysis model, geo-analysis model subsystem, or component of a geo-analysis model.

6. The geo-analysis model componentized presenter of claim 3, wherein the multiplicity of guideways are configured and adapted to move specified raw materials required by the geographical model to or from the assembly tray.

7. The geo-analysis model componentized presenter of claim 6, wherein the multiplicity of guideways comprise magnetic guideways configured to move specified raw materials required by the geographical model to the assembly tray by magnetic force.

8. The geo-analysis model componentized presenter of claim 3, wherein the supporting table comprises a multiplicity of table boundaries, and a multiplicity of boundary baffles, each boundary baffle, respectively, located at or near a respective table boundary.

9. The geo-analysis model componentized presenter of claim 3, wherein the supporting table comprises a boundary detector configured and adapted to sense when one or more physical objects on the table extend in whole or in part beyond a respective table boundary.

10. The geo-analysis model componentized presenter of claim 2, wherein the general controller comprises a power cord, a network interface, a switch panel, an operation display, an operation panel, and a model access module.

11. The geo-analysis model componentized presenter of claim 10, wherein the power cord is configured and adapted to provide power for the geo-analysis model parsing and assembly device.

12. The geo-analysis model componentized presenter of claim 10, wherein the network interface is configured and adapted to provide network connection for the entire geo-analysis model parsing and assembly device.

13. The geo-analysis model componentized presenter of claim 11, wherein the switch panel is configured and adapted to connect or disconnect the power cord.

14. The geo-analysis model componentized presenter of claim 10, wherein the operation display is configured and adapted to show selected information of the imported geo-analysis model on the display.

15. The geo-analysis model componentized presenter of claim 10, wherein the operation panel is configured and adapted to allow the user to select and import model information.

16. The geo-analysis model componentized presenter of claim 2, wherein the model access module is configured and adapted to import the geo-analysis model into a geographic model format.

17. A geo-analysis model componentized presentation process for delivering improved representation of a geo-analysis model to a user via a model object, the process comprising:
activating an input control module to input model information;
activating an assembly control module to assemble a model object from model components, based on the model information; and
presenting the model object to the user.

18. The process of claim 17, wherein:
the input control module comprises:
an input operation;
a model access operation, and
a model parser operation; and
the assembly control module comprises:
an assembly rules library,
an assembly controller, and
a relative motion controller.

19. The process of claim 18, wherein:
the input operation comprises reading a data element in a geo-analysis model format;
the model access operation comprises converting the data element from the geo-analysis model format to a geographic model format;
the model parser operation comprises removing one or more conceptual characteristics of the geo-analysis model, and defining a final shape of a geographic model;
the assembly rules library comprises a series of assembly rules with a mix calling interface;
the assembly controller is an assembly tray controller configured and adapted to route, position, or place specified raw material supplies or physical components of geographical models;
the relative motion controller is a magnetic motion controller; and
the model object comprises:
at least one model subject,
a multiplicity of model-submodules,
a multiplicity of input/output plugs, and
a multiplicity of workflow indicators.

20. A geo-analysis model componentized presenter for creating an improved representation of a geo-analysis model for a user, the presenter comprising a geo-analysis model parsing and assembly device and an assembled physical object representation of the geo-analysis model;
wherein the geo-analysis model parsing and assembly device comprises a supporting device and a general controller;
wherein the supporting device comprises a multiplicity of raw material supplies, an assembly tray, a multiplicity of guideways, and a supporting table;
herein the multiplicity of raw material supplies comprises a submodule raw material supply, a model subject raw material supply, a workflow indicator sub-module raw material supply, and an input/output plug raw material supply;
wherein the assembly tray is configured and adapted to route, position, or place specified raw material supplies or physical components of geographical models to represent the combination of a specified geo-analysis model, geo-analysis model subsystem, or component of a geo-analysis model;
wherein the multiplicity of guideways are configured and adapted to move specified raw materials required by the geographical model to or from the assembly tray;
wherein the multiplicity of guideways comprise magnetic guideways configured to move specified raw materials required by the geographical model to the assembly tray by magnetic force;
wherein the supporting table comprises a multiplicity of table boundaries, and a multiplicity of boundary baffles, each boundary baffle, respectively, located at or near a respective table boundary;
wherein the supporting table comprises a boundary detector configured and adapted to sense when one or more physical objects on the table extend in whole or in part beyond a respective table boundary;
wherein the general controller comprises a power cord, a network interface, a switch panel, an operation display, an operation panel, and a model access module;
wherein the power cord is configured and adapted to provide power for the geo-analysis model parsing and assembly device;
wherein the network interface is configured and adapted to provide a network connection for the entire geo-analysis model parsing and assembly device;
wherein the switch panel is configured and adapted to connect or disconnect the power cord;
wherein the operation display is configured and adapted to show selected information of the imported geo-analysis model on display;
wherein the operation panel is configured and adapted to allow the user to select and import model information;
wherein the model access module is configured and adapted to import the geo-analysis model into a geographic model format.
